(19) United States
(12) Patent Application Publication
(10) Pub. No.: US 2023/0394904 A1
(43) Pub. Date: Dec. 7, 2023

(54) SYSTEMS AND METHODS FOR EVALUATING AND RECYCLING ELECTRONIC DEVICES

(71) Applicant: ecoATM, LLC, San Diego, CA (US)

(72) Inventors: Babak Forutanpour, San Diego, CA (US); Ted Ray Gooding, San Diego, CA (US)

(21) Appl. No.: 18/327,764

(22) Filed: Jun. 1, 2023

Related U.S. Application Data
(60) Provisional application No. 63/365,778, filed on Jun. 2, 2022.

(51) Int. Cl. G07F 7/06; G06Q 20/18; G06Q 30/02

(52) U.S. Cl. CPC G07F 7/06; G06Q 20/18; G06Q 30/0278

(57) ABSTRACT

Hardware and software application systems and associated methods for obtaining information from, evaluating, and pricing mobile phones, tablet computers, laptop computers, and/or other electronic devices for recycling and/or other processing are described herein. In various embodiments, the present technology includes systems and methods associated with a kiosk that can determine a condition of a screen of an electronic device. In some embodiments, the present technology includes displaying one or more test images on the screen of the electronic device, using one or more cameras of the kiosk to display the test images, evaluating the screen based on the as-displayed test images, etc. In some embodiments, the electronic device is place in a camera mode and one or more cameras of the electronic device are used to display the test images on the electronic device screen. Various other aspects of the present technology are described herein.

### CROSS-REFERENCE TO RELATED APPLICATION

The present application claims priority to U.S. Provisional App. No. 63/365,778, titled “SYSTEMS AND METHODS FOR EVALUATING AND RECYCLING ELECTRONIC DEVICES,” and filed Jun. 2, 2022, the entirety of which is incorporated by reference herein.

### TECHNICAL FIELD

The present disclosure is directed generally to methods and systems for evaluating and recycling mobile phones and other consumer electronic devices and, more particularly, to hardware and/or software for facilitating device identification, evaluation, purchase, and/or other processes associated with electronic device recycling.

### BACKGROUND

Consumer electronic devices, such as mobile phones, laptop computers, notebooks, tablets, MP3 players, etc., are ubiquitous. According to some estimates, the number of mobile devices is expected to reach over 17 billion by 2024. With the ever-expanding number of mobile devices, there is a need for continual replacements and upgrades, leaving an overwhelming number of used and/or discarded devices. Many or most of these devices can end up in landfills or disposed of in developing countries. These devices often contain substances that are harmful to the environment, such as arsenic, lithium, cadmium, copper, lead, mercury and zinc. If not properly disposed of, these toxic substances can seep into groundwater from decomposing landfills and contaminate the soil with potentiality harmful consequences for humans and the environment.

As an alternative to retailer trade-in or buyback programs, consumers can now recycle and/or sell their used mobile phones using self-service kiosks located in malls, retail stores, or other publicly accessible areas. Such kiosks are operated by ecoATM, Inc., the assignee of the present application. There continues to be a need for improving the means available to consumers for recycling or reselling their mobile phones and other electronic devices. Simplifying the recycling/reselling process, enhancing the consumer experience, and discouraging fraud can incentivize consumers to dispose of their old electronic devices in an efficient and environmentally conscientious way.

### BRIEF DESCRIPTION OF THE DRAWINGS

FIG. 1 is an isometric view of a kiosk for recycling mobile phones and/or other electronic devices configured in accordance with an embodiment of the present technology.

FIG. 2A-2D are a series of isometric views of the kiosk of FIG. 1 with exterior panels removed to illustrate operation of the kiosk in accordance with an embodiment of the present technology.

FIG. 3A is a front view of an example electronic device in accordance with embodiments of the present technology.

FIG. 3B is a rear view of the example electronic device of FIG. 3A.

FIG. 4 is a partially schematic side view of the electronic device of FIGS. 3A and 3B in an inspection area of the kiosk of FIG. 1, in accordance with embodiments of the present technology

FIG. 5A illustrates an example evaluation image that can be used to evaluate a display screen of an electronic device, in accordance with embodiments of the present technology.

FIGS. 5B-5D are respectively, partially schematic front views of screens of electronic devices displaying the evaluation image of FIG. 5A, as viewed from the perspective of line A-A in FIG. 4.

FIG. 6A illustrates an example evaluation image that can be used to evaluate a display screen of an electronic device, in accordance with embodiments of the present technology.

FIGS. 6B-6D are partially schematic front views of screens of electronic devices displaying the evaluation image of FIG. 6A, as viewed from the perspective of line A-A in FIG. 4.

FIG. 7A-7C are a series of front views of portions of a display screen of an electronic device illustrating pixel groups.

FIG. 8 is a flow diagram of a routine for recycling mobile phones and/or other electronic devices in accordance with an embodiment of the present technology.

FIG. 9 is a flow diagram of a routine for pricing an electronic device in accordance with embodiments of the present technology.

### DETAILED DESCRIPTION

The following disclosure describes various embodiments of hardware and/or software systems and methods that facilitate the identification, evaluation, purchase, and/or other processes associated with purchasing and/or recycling of mobile phones and other electronic devices (e.g., tablets, computers, IPOD® devices, MP3 Players, GPS devices, e-readers, laptops, TVs, or any other suitable electronic device). In some embodiments, the present technology includes a kiosk configured to evaluate one or more mobile phones, e.g., as part of a return or recycling process. As used herein, the term recycling can include purchasing mobile phones for subsequent resale, as well as collecting mobile phones for safe disposal and/or reuse of certain materials in the phone. The mobile phones and other electronic devices can include a screen or display, and the kiosk can be configured to determine a condition of the screen. In at least some embodiments, for example, a mobile phone can be placed in an inspection area of the kiosk while the screen displays a test image, and the phone can be positioned such that the displayed test image is within a field of view of one or more kiosk cameras. The kiosk cameras can capture one or more images of the test image as displayed by the screen, and the kiosk can process the captured image to evaluate the condition of the screen.

In some embodiments, the mobile phone or other electronic can include at least one camera, and the phone can be placed into a camera or photo mode before the kiosk evaluates the condition of the display. While in camera mode, the phone can be prevented, inhibited, or delayed from locking, powering off, and/or dimming the screen. Some conventional systems for evaluating the screens of mobile phones are generally limited or constrained by the amount of time during which the screen remains active or powered on. When using such systems, the screen evaluation process may fail and/or require a user to repeat one or more steps of the evaluation process if the phone locks or the phone's display screen turns off. This can discourage the user from completing a return or recycle transaction. In contrast, systems and methods configured in accordance with the present technology can evaluate the phone's display screen before the phone powers off, dims, and/or locks the screen. Accordingly, the present technology is expected to be more user-friendly and less susceptible to failure.

In a further aspect of the present technology, the mobile phone's display screen can be used to display one or more test images, e.g., while the mobile phone is in the inspection area of the kiosk. These test images may be displayed via one or more of the mobile phone's cameras (e.g., while the mobile phone is positioned within the inspection area of the kiosk). While the mobile phone's display screen is displaying the test image(s), one or more cameras within the kiosk can capture one or more images of the mobile phone, its display screen, and/or the test image as it is displayed on the mobile phone's display screen. The kiosk can then analyze these captured images to evaluate the mobile phone's screen. For example, the kiosk can be configured to compare an expected test image to how that test image is displayed by the mobile phone's display screen to, e.g., determine a condition of the display screen. In some embodiments, the kiosk can include one or more lighting elements positioned in an upper and/or lower chamber of the kiosk (e.g., inner walls of the kiosk) and oriented to illuminate the field of view of one or more of the mobile phone's cameras. When individual ones of the lighting elements are active and the mobile phone is placed in camera mode, the mobile phone's screen can display a test image corresponding to, e.g., a color, brightness, etc. of the lighting elements. When individual ones of the lighting elements are inactive, the mobile phone's screen can be correspondingly darkened or dimmed. The kiosk can evaluate the mobile phone's screen in response to the illumination (or lack thereof) provided by the lighting elements to determine a condition of the mobile phone's screen.

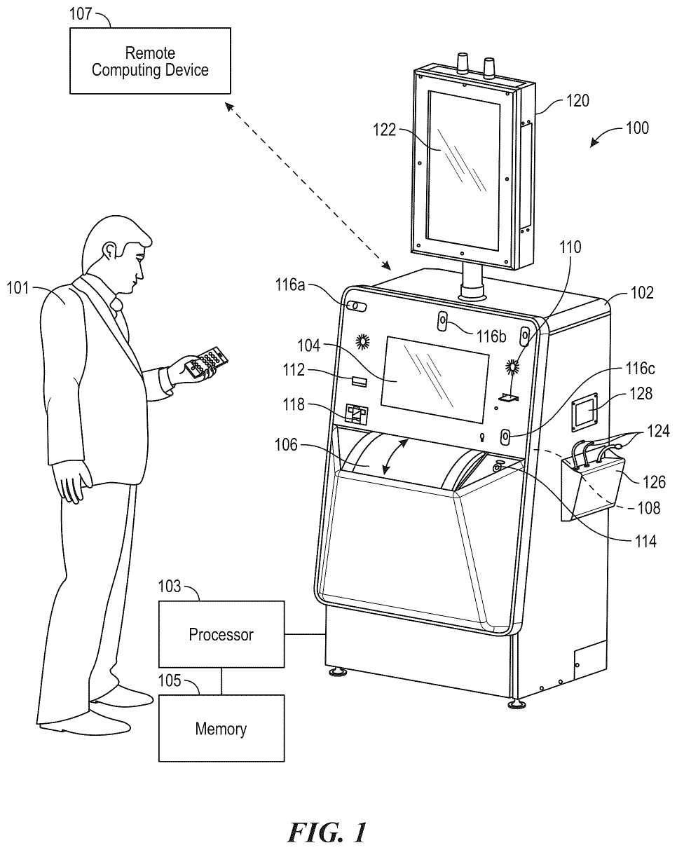

Certain details are set forth in the following description and in FIGS. 1-9 to provide a thorough understanding of various embodiments of the present technology. In other instances, well-known structures, materials, operations and/or systems often associated with smartphones and other handheld devices, consumer electronic devices, computer hardware, software, and network systems, etc. are not shown or described in detail in the following disclosure to avoid unnecessarily obscuring the description of the various embodiments of the technology. Those of ordinary skill in the art will recognize, however, that the present technology can be practiced without one or more of the details set forth herein, or with other structures, methods, components, and so forth. The terminology used below should be interpreted in its broadest reasonable manner, even though it is being used in conjunction with a detailed description of certain examples of embodiments of the technology. Indeed, certain terms may even be emphasized below; however, any terminology intended to be interpreted in any restricted manner will be specifically defined as such in this Detailed Description section.

The accompanying Figures depict embodiments of the present technology and are not intended to be limiting of its scope. The sizes of various depicted elements are not necessarily drawn to scale, and these various elements may be arbitrarily enlarged to improve legibility. Component details may be abstracted in the Figures to exclude details such as the position of components and certain precise connections between such components when such details are unnecessary for a complete understanding of how to make and use the invention.

In the Figures, identical reference numbers identify identical, or at least generally similar, elements. To facilitate the discussion of any particular element, the most significant digit or digits of any reference number refers to the Figure in which that element is first introduced. For example, element 110 is first introduced and discussed with reference to FIG. 1.

FIG. 1 is an isometric view of a kiosk 100 for recycling and/or other processing of mobile phones and other consumer electronic devices in accordance with the present technology. The term “processing” is used herein for ease of reference to generally refer to all manner of services and operations that may be performed or facilitated by the kiosk 100 on, with, or otherwise in relation to an electronic device. Such services and operations can include, for example, selling, reselling, recycling, donating, exchanging, identifying, evaluating, pricing, auctioning, decommissioning, transferring data from or to, reconfiguring, refurbishing, etc., mobile phones and other electronic devices. Although many embodiments of the present technology are described in the context of mobile phones, aspects of the present technology are not limited to mobile phones and generally apply to other electronic devices. Such devices include, as non-limiting examples, all manner of mobile phones, smart phones, handheld devices, PDAs, MP3 players, tablet, notebook and laptop computers, e-readers, cameras, etc. In some embodiments, it is contemplated that the kiosk 100 can facilitate selling and/or otherwise processing larger electronic devices, such as desktop computers, TVs, game consoles, etc., as well smaller electronic devices such as Google Glass™, smartwatches, etc. The kiosk 100 and various features thereof can be at least generally similar in structure and function to the kiosks and corresponding features described in any of the U.S. patents incorporated by reference herein.

In the illustrated embodiment, the kiosk 100 is a floor-standing self-service kiosk configured for use by a user 101 (e.g., a consumer, customer, etc.) to recycle, sell, and/or perform other operations with a mobile phone or other consumer electronic device. In other embodiments, the kiosk 100 can be configured for use on a countertop or a similar raised surface. Although the kiosk 100 is configured for use by consumers, in various embodiments the kiosk 100 and/or various portions thereof can also be used by other operators, such as a retail clerk or kiosk assistant to facilitate the selling or other processing of mobile phones and other electronic devices.

In the illustrated embodiment, the kiosk 100 includes a housing 102 that can be approximately the size of a conventional vending machine. The housing 102 can be of conventional manufacture from, for example, sheet metal, plastic panels, etc. A plurality of user interface devices can be provided on a front portion of the housing 102 for providing instructions and other information to users, and/or for receiving user inputs and other information from users. For example, the kiosk 100 can include a display screen 104 (e.g., a liquid crystal display (“LCD”) or light emitting diode (“LED”) display screen, a projected display (such as a heads-up display or a head-mounted device), and so on) for providing information, prompts, etc., to users. The display screen 104 can include a touch screen for receiving user input and responses to displayed prompts. In addition, or alternatively, the kiosk 100 can include a separate keyboard or keypad for this purpose. The kiosk 100 can also include an ID reader or scanner 112 (e.g., a driver's license scanner), a fingerprint reader 114, and/or one or more cameras 116 (e.g., identified individually as cameras 116a-c, and which can each include one or more digital still and/or video cameras). The kiosk 100 can include one or more output devices such as a label printer having an outlet 110, and a cash dispenser having an outlet 118. Although not identified in FIG. 1, the kiosk 100 can further include a speaker and/or a headphone jack for audibly communicating information to users, one or more lights for visually communicating signals or other information to users, a handset or microphone for receiving verbal input from the user, a card reader (e.g., a credit/debit card reader, loyalty card reader, etc.), a receipt or voucher printer and dispenser, as well as other user input and output devices. The input devices can include a touchpad, pointing device such as a mouse, joystick, pen, game pad, motion sensor, scanner, eye direction monitoring system, etc. Additionally the kiosk 100 can also include a bar code reader, QR code reader, bag/package dispenser, a digital signature pad, etc. In the illustrated embodiment, the kiosk 100 additionally includes a header 120 having a display screen 122 for displaying marketing advertisements and/or other video or graphical information to attract users to the kiosk. In some embodiments, the header 120 and associated components are manufactured as part of the housing 102. In addition to the user interface devices described above, the front portion of the housing 102 also includes an access panel or door 106 located directly beneath the display screen 104. As described in greater detail below, the access door 106 is configured to automatically retract so that the user 101 can place an electronic device (e.g., a mobile phone) in an inspection area 108 for automatic inspection by the kiosk 100.

A sidewall portion of the housing 102 can include a number of conveniences to help users recycle or otherwise process their mobile phones. For example, in the illustrated embodiment the kiosk 100 includes an accessory bin 128 that is configured to receive mobile device accessories that the user wishes to recycle or otherwise dispose of. Additionally, the kiosk 100 can provide a free charging station 126 with a plurality of electrical connectors 124 for charging a wide variety of mobile phones and other consumer electronic devices. In some embodiments, the kiosk 100 includes an ultraviolet chamber or other cleaning device configured to disinfect or otherwise clean a user's mobile phone or other electronic device.

The kiosk 100 can further include one or more processors or processing devices 103 and one or more memory or another non-transitory computer readable medium 105. The processors 103 can include CPUs, GPUs, or any other suitable processing device. Any of the elements of the kiosk 100 can be operably coupled to at least one of the processors 103, such that the processors 103 can control operation of one or more of the elements of the kiosk 100. The memory 105 can store computer readable instructions that can be executed by the processors 103, e.g., to cause the processors 103 and/or the kiosk 100 to perform one or more functions (e.g., “open the access door 106”, “display a prompt on the display screen 104”, etc.). In some embodiments, the kiosk 100 can be communicatively connected to a remote computing device 107, such as a remote server, processor, and/or memory or data storage device. The kiosk 100 can be connected to the remote computing device 107 via a wired, wireless, or any other suitable connection. The remote computing device 107 can be positioned remote from the kiosk 100, e.g., in a different room, building, city, zip code, state, country, continent, etc.

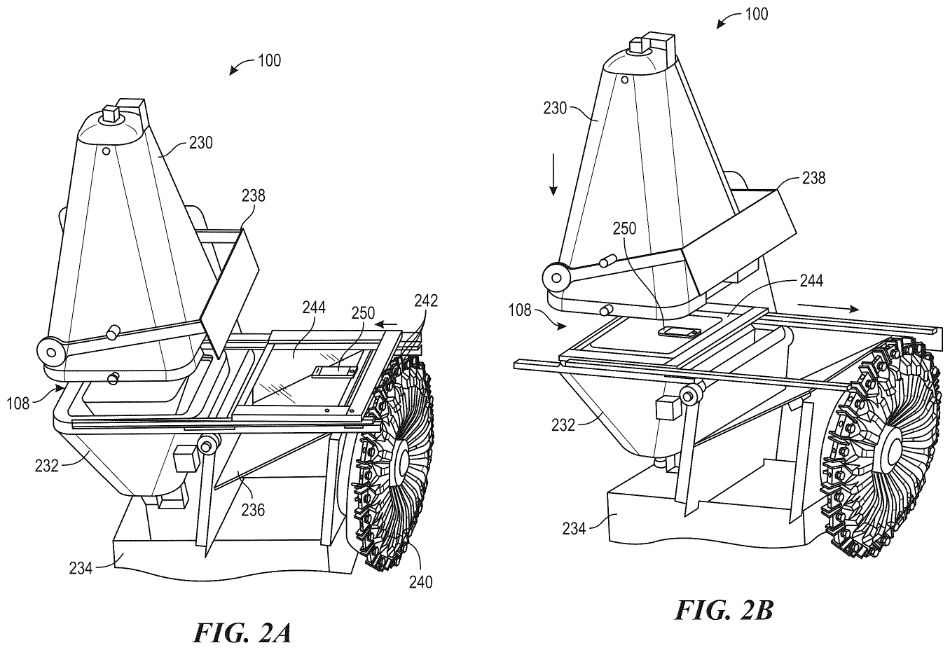

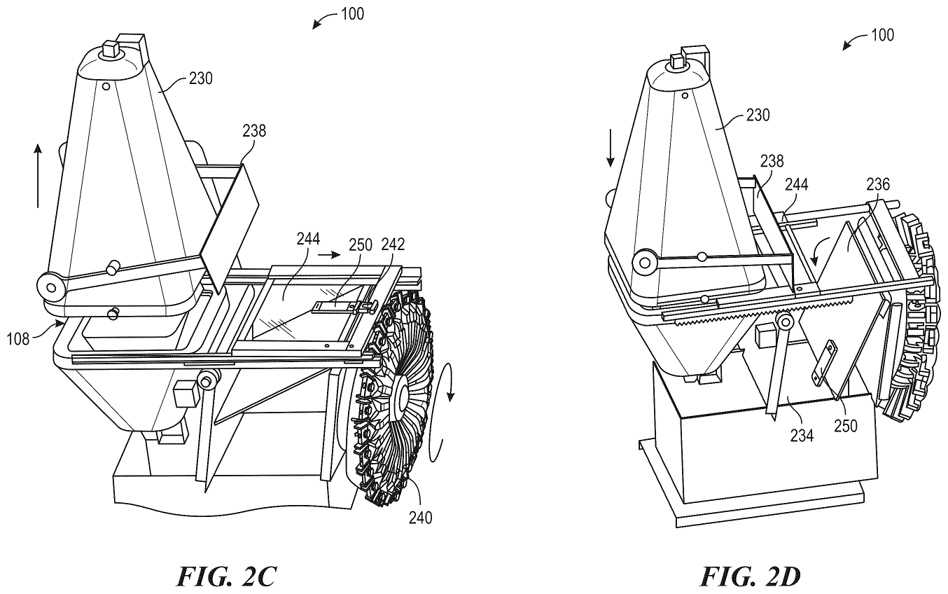

FIGS. 2A-2D are a series of isometric views of the kiosk 100 with the housing 102 removed to illustrate selected internal components configured in accordance with an embodiment of the present technology. Referring first to FIG. 2A, in the illustrated embodiment the kiosk 100 includes a connector carrier 240 and an inspection plate 244 operably disposed behind the access door 106 (FIG. 1). In the illustrated embodiment, the connector carrier 240 is a rotatable carrousel that is configured to rotate about an axis (e.g., a generally horizontal axis) and carries a plurality of electrical connectors 242 (e.g., approximately 25 connectors) distributed around an outer periphery thereof. In other embodiments, other types of connector-carrying devices (including both fixed and movable arrangements) can be used. In some embodiments, the connectors 242 can include a plurality of interchangeable USB connectors configured to provide power and/or exchange data with a variety of different mobile phones and/or other electronic devices. In operation, the connector carrier 240 is configured to automatically rotate about its axis to position an appropriate one of the connectors 242 adjacent to an electronic device, such as a mobile phone 250, that has been placed on the inspection plate 244 for recycling. The connector 242 can then be manually and/or automatically withdrawn from the connector carrier 240 and connected to a port on the mobile phone 250 for electrical analysis. Such analysis can include, e.g., an evaluation of the make, model, configuration, condition, etc., using one or more of the methods and/or systems described in detail in the commonly owned patents and patent applications identified herein and incorporated by reference in their entireties.

In the illustrated embodiment, the inspection plate 244 is configured to translate back and forth (on, e.g., parallel mounting tracks) to move an electronic device, such as the mobile phone 250, between a first position directly behind the access door 106 and a second position between an upper chamber 230 and an opposing lower chamber 232. Moreover, in this embodiment the inspection plate 244 is transparent, or at least partially transparent (e.g., formed of glass, Plexiglas, etc.) to enable the mobile phone 250 to be photographed and/or otherwise optically evaluated from all, or at least most viewing angles (e.g., top, bottom, sides, through the inspection plate, etc.) using, e.g., one or more cameras, mirrors, etc. mounted to or otherwise associated with the upper and lower chambers 230 and 232. When the mobile phone 250 is in the second position, the upper chamber 230 can translate downwardly to generally enclose the mobile phone 250 between the upper chamber 230 and the lower chamber 232. The upper chamber 230 can be operably coupled to a gate 238 that moves up and down in unison with the upper chamber 230. As noted above, in the illustrated embodiment the upper chamber 230 and/or the lower chamber 232 can include one or more cameras, magnification tools, scanners (e.g., bar code scanners, infrared scanners, etc.) or other imaging components (not shown) and an arrangement of mirrors (also not shown) to view, photograph and/or otherwise visually evaluate the mobile phone 250 from multiple perspectives. In some embodiments, one or more of the cameras and/or other imaging components discussed above can be movable to facilitate device evaluation. The inspection area 108 can also include weight scales, heat detectors, UV readers/detectors, and the like, for further evaluation of electronic devices placed therein. The kiosk 100 can further include an angled binning plate 236 for directing electronic devices from the transparent plate 244 into a collection bin 234 positioned in a lower portion of the kiosk 100.

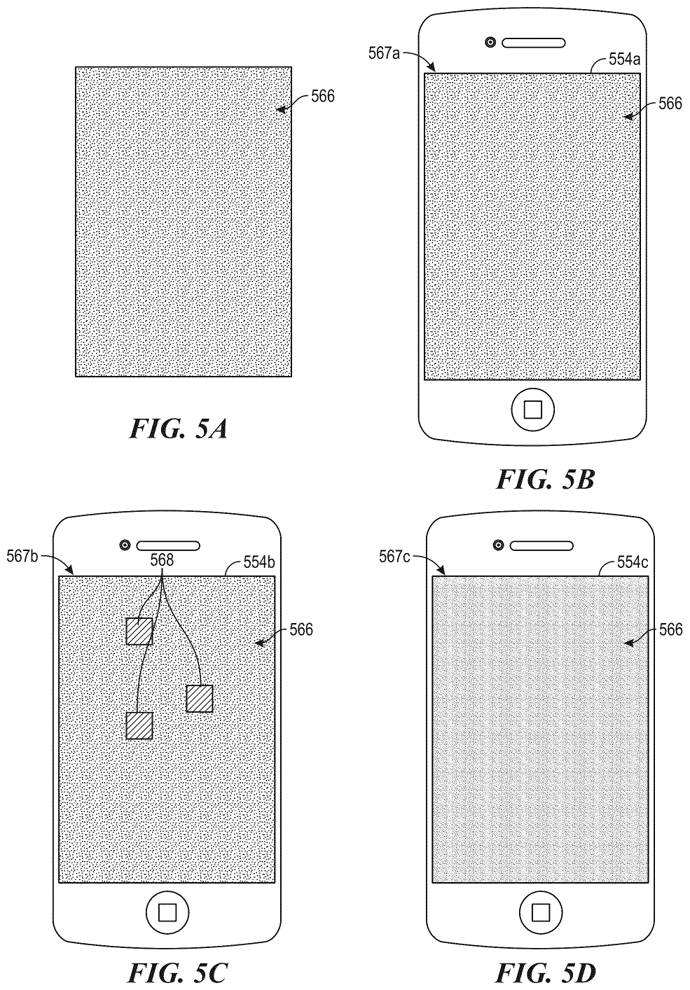

The kiosk 100 can be used in a number of different ways to efficiently facilitate the recycling, selling and/or other processing of mobile phones and other consumer electronic devices. Referring to FIGS. 1-2D together, in one embodiment a user wishing to sell a used mobile phone, such as the mobile phone 250, approaches the kiosk 100 and identifies the type of device the user wishes to sell in response to prompts on the display screen 104. Next, the user may be prompted to remove any cases, stickers, or other accessories from the device so that it can be accurately evaluated. Additionally, the kiosk 100 may print and dispense a unique identification label (e.g., a small adhesive-backed sticker with a quick response code (“QR code”), barcode, or other machine-readable indicia, etc.) from the label outlet 110 for the user to adhere to the back of the mobile phone 250. After this is done, the door 106 retracts and opens allowing the user to place the mobile phone 250 onto the transparent plate 244 in the inspection area 108 (FIG. 2A). The door 106 then closes and the transparent plate 244 moves the mobile phone 250 under the upper chamber 230 as shown in FIG. 2B. The upper chamber 230 then moves downwardly to generally enclose the mobile phone 250 between the upper and lower chambers 230 and 232, and the cameras and/or other imaging components in the upper and lower chambers 230 and 232 perform a visual inspection of the mobile phone 250. In some embodiments, the visual inspection can include a computer-implemented visual analysis (e.g., a three-dimensional (“3D”) analysis) performed by a processing device within the kiosk (e.g., the processor 103, a CPU, etc.) to confirm the identification of the mobile phone 250 (e.g. make, model and/or sub-model) and/or to evaluate or assess the condition and/or function of the mobile phone 250 and/or its various components and systems. For example, the visual analysis can include computer-implemented evaluation (e.g., a digital comparison) of images of the mobile phone 250 taken from top, side and/or end view perspectives to determine length, width, and/or height (thickness) dimensions of the mobile phone 250. The visual analysis can further include a computer-implemented inspection of a display screen on the mobile phone 250 to check for, e.g., cracks in the glass and/or other damage or defects in the LCD (e.g., defective pixels, etc.). The inspection of the display screen on the mobile phone 250 is described in greater detail below with reference to FIGS. 5A-9. In some embodiments, the kiosk 100 can perform the visual analysis using one or more of the methods and/or systems described in detail in the commonly owned patents and patent applications identified herein and incorporated by reference in their entireties.

Referring next to FIG. 2C, after the visual analysis is performed and the device has been identified, the upper chamber 230 returns to its upper position and the transparent plate 244 returns the mobile phone 250 to its initial position near the door 106. The display screen 104 can also provide an estimated price, or an estimated range of prices, that the kiosk 100 may offer the user for the mobile phone 250 based on the visual analysis, and/or based on user input (e.g., input regarding the type, condition, etc. of the phone 250). If the user indicates (via, e.g., input via the touch screen) that they wish to proceed with the transaction, the connector carrier 240 automatically rotates an appropriate one of the connectors 242 into position adjacent the transparent plate 244, and door 106 is again opened. The user can then be instructed (via, e.g., the display screen 104) to withdraw the selected connector 242 (and its associated wire) from the carrousel 240, plug the connector 242 into the corresponding port (e.g., a USB port) on the mobile phone 250, and reposition the mobile phone 250 in the inspection area on the transparent plate 244. After doing so, the door 106 once again closes and the kiosk 100 (e.g., the kiosk CPU) performs an electrical inspection of the device via the connector 242 to further evaluate the condition of the phone as well as specific component and operating parameters such as the memory, carrier, etc. In some embodiments, the electrical inspection can include a determination of phone manufacturer information (e.g., a vendor identification number or VID) and product information (e.g., a product identification number or PID). In some embodiments, the kiosk 100 can perform the electrical analysis using one or more of the methods and/or systems described in detail in the commonly owned patents and patent applications identified herein and incorporated by reference in their entireties.

After the visual and electronic analysis of the mobile phone 250, the user is presented with a phone purchase price (e.g., via the display screen 104). If the user declines the price (via, e.g., the touch screen), a retraction mechanism (not shown) automatically disconnects the connector 242 from the mobile phone 250, the door 106 opens, and the user can reach in and retrieve the mobile phone 250. If the user accepts the price, the door 106 remains closed and the user may be prompted to place his or her identification (e.g., a driver's license) in the ID scanner 112 and provide a thumbprint via the fingerprint reader 114. In some embodiments, the user is prompted to place his or her identification in front of an external camera 116 of the kiosk 100 or onto the plate 244 so that the kiosk 100 can image the identification using one of the built-in cameras. As a fraud prevention measure, the kiosk 100 can be configured to transmit an image of the driver's license to a remote computer screen, and an operator at the remote computer can visually compare the picture (and/or other information) on the driver's license to an image of the person standing in front of the kiosk 100 as viewed by one or more of the cameras 116a-c (FIG. 1) to confirm that the person attempting to sell the phone 250 is in fact the person identified by the driver's license. In some embodiments, one or more of the cameras 116a-c can be movable to facilitate viewing of kiosk users, as well as other individuals in the proximity of the kiosk 100. Additionally, the person's fingerprint can be checked against records of known fraud perpetrators. If either of these checks indicate that the person selling the phone presents a fraud risk, the transaction can be declined and the mobile phone 250 returned. After the user's identity has been verified, the transparent plate 244 moves back toward the upper and lower chambers 230 and 232. As shown in FIG. 2D, however, when the upper chamber 230 is in the lower position the gate 238 permits the transparent plate 244 to slide underneath but not electronic devices carried thereon. As a result, the gate 238 knocks the mobile phone 250 off of the transparent plate 244, onto the binning plate 236 and into the bin 234. The kiosk can then provide payment of the purchase price to the user. In some embodiments, payment can be made in the form of cash dispensed from the cash outlet 118. In other embodiments, the user can receive remuneration for the mobile phone 250 in various other useful ways. For example, the user can be paid via a redeemable cash voucher, a coupon, an e-certificate, a prepaid card, a wired or wireless monetary deposit to an electronic account (e.g., a bank account, credit account, loyalty account, online commerce account, mobile wallet etc.), cryptocurrency, etc.

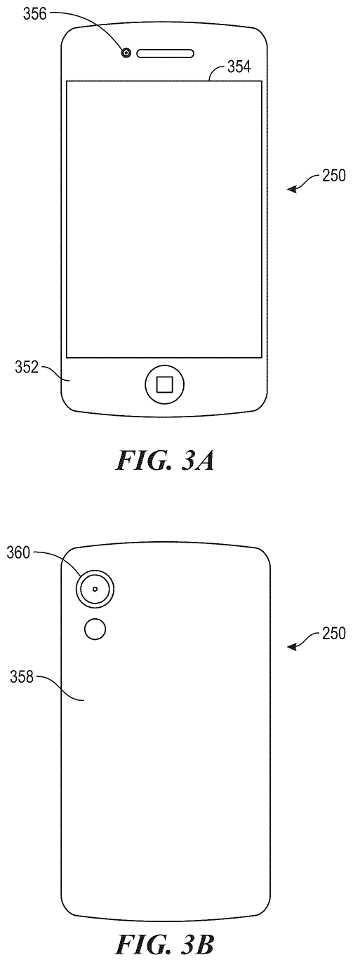

FIGS. 3A and 3B are front and rear views, respectively, of an example electronic device, such as the mobile phone 250, in accordance with embodiments of the present technology. Referring to FIG. 3A, the phone 250 can include a first (e.g., front) side or surface 352 comprising a display screen 354 (which can also be referred to as a “display” or “screen”) and one or more first (e.g., front) cameras 356. The screen 354 can be an LCD display, an OLED display, an e-ink display, and/or any other display. Turning to FIG. 3B, the phone 250 includes a second (e.g., rear) side 358 opposite the first side. The second side 358 of the phone 250 can include one or more second (e.g., rear, backside, etc.) cameras 360.

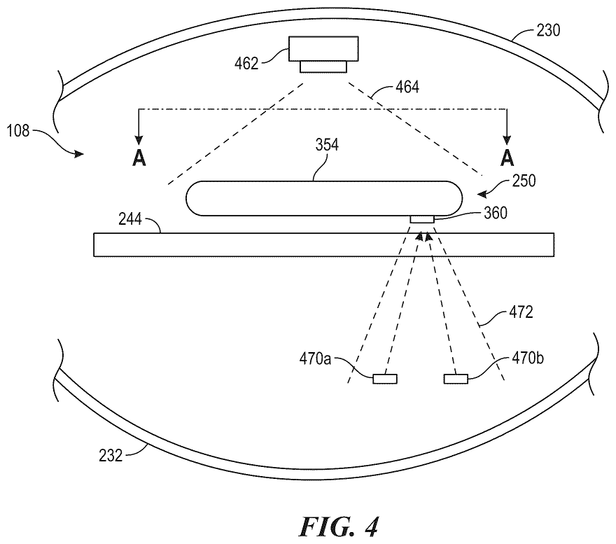

FIG. 4 is a schematic illustration of a side view of the phone 250 in an inspection area of a kiosk, such as the inspection area 108 of the kiosk 100. FIG. 4 includes a gap between the mobile phone 250 and the inspection plate 244 for the sake of illustrative clarity; it will be appreciated that, in practice, all or part of the mobile phone 250 can contact (e.g., rest directly on) the inspection plate 244. As described previously, the inspection area 108 can include one or more cameras 462 positioned above and/or below the inspection plate 244. In the illustrated embodiment, the inspection area 108 includes one camera 462 positioned in the upper chamber or dome 230 above the inspection plate 244. The mobile phone 250 can be positioned on the inspection plate 244 such that the phone's screen 354 is within a field of view 464 of the camera 462. Accordingly, the camera 462 can be used to monitor and/or capture images of the mobile phone 250, including the mobile phone's screen 354 and/or any images displayed on the mobile phone's screen 354.

In some embodiments the mobile phone 250 can be placed in a camera or photo mode before, during, and/or after the mobile phone 250 is positioned in the inspection area 108, such that the screen 354 of the mobile phone 250 is configured to remain active and/or in an unlocked state. With the mobile phone 250 in camera mode, the first camera 356 (FIG. 3A) and/or the second camera 360 of the phone 250 can be used to display images on the mobile phone's screen 354. Accordingly, the display screen 354 can, via at least one of the phone's cameras, display an image that can correspond to the light (e.g., a brightness, a color, a hue, a tint, a tone, a shade, a saturation, etc., of the light) emitted by the lighting element(s) 470a-b. Because the mobile phone 250 is in camera mode, a change to the light emitted by one of the lighting elements 470a-b can cause a corresponding change to the image shown on the display screen 354. For example, individual ones of the lighting element 470a-b can be dimmed or turned off to reduce the brightness of the image shown on the display screen 354 and/or to cause the display screen 354 to show a dark grey or black image. In some embodiments, the inspection area 108 can include one or more the lighting element(s) 470a-b configured to illuminate a field of view 472 of the second camera 360. For example, one or more of the lighting elements 470a-b can be positioned within the field of view 472 of the second camera 360 such that the lighting elements 470a-b directly illuminate the second camera 360. In the illustrated embodiment, the one or more lighting elements 470a-b (e.g., LEDs, light bulbs, etc.) are positioned in the lower chamber 232 and oriented such that light from at least one of the lighting elements 470a-b is incident on the mobile phone's 250 second camera 360. In these and other embodiments, one or more of the lighting elements 470a-b are not in the field of view 472 of the camera 360, and/or are positioned to illuminate a portion of the inspection area 108 (e.g., an inner wall or other surface of the lower chamber 232) within the field of view 472 of the camera 360. For example, a portion of the inspection area 108 can be a white (or lightly-colored) wall that, when illuminated by the lighting elements 470a-b, will reflect the color of the lighting elements 470a-b. The lighting elements 470a-b can be positioned relative to the field of view 472 of the second camera 360 so that, when the mobile phone 250 is in camera mode, the display 354, via the second camera 360, can be uniformly illuminated. In these and other embodiments, any of the lighting elements described herein can be a display screen (e.g., an LCD display screen, an OLED display screen, etc.) configured to display one or more images, videos, and/or patterns that can be shown on the display screen 354 via at least one of the cameras of the mobile phone 250. In some embodiments, the lighting element(s) 470a-b are configured to project a non-uniform image or pattern onto a surface of the inspection area 108. Additionally, or alternatively, one or more of the lighting elements 470a-b can be positioned in the upper chamber 230 and oriented such that light from at least one of the additional lighting elements is incident on the first camera 356 (FIG. 3A) when the mobile phone 250 is in camera mode that activates the first camera 356 (e.g., a “selfie” mode).

In some embodiments, one or more lighting elements 470a-b can be mounted or coupled to the inspection plate 244 and configured to illuminate the field of view of the first camera 356 or the second camera 360. For example, at least a portion of the inspection plate 244 can be partially or fully transparent, the mobile phone 250 can be placed on the inspection plate 244 with at least one of the cameras facing the transparent portion of the inspection plate 244, and the lighting elements 470a-b can be positioned to illuminate the camera's field of view 472 through the transparent portion of the inspection plate 244. In other embodiments, at least a portion of the inspection plate 244 can be partially or fully opaque (e.g., constructed from an enamel, metal, ceramic, polymer, composite, etc.), and the phone 250 can be positioned in the inspection area 108 such that lighting element(s) in the upper chamber 230 illuminate the field of view of the first camera 356 (e.g., with the first side 352 of the phone 250 facing the upper chamber 230 and the second side 358 at least partially contacting the inspection plate 244 and/or the opaque portion). Moreover, in at least some embodiments, one or more mirrors (not shown) can be positioned in the upper chamber 230 and/or the lower chamber 232 to reflect light from the lighting element(s) 470a-b toward and/or into the field of view of the first camera 356 and/or the second camera 360.

FIG. 5A illustrates an example evaluation or test image 566 that can be used to evaluate the mobile phone's display screen 354. The test image 566 can include one or more known or otherwise predetermined colors, patterns, objects, and/or any other suitable visual and/or graphic indicia. In some embodiments the test image 566 is a single color (e.g., white, black, red, green, blue, etc.). Although a single test image 566 is shown in FIG. 5A, it will be appreciated that, in at least some embodiments, the test image 566 can be one image in a series or sequence of images, so that the series and/or one or more images thereof can include one or more patterns and/or colors. In at least some embodiments, for example, the test image 566 can be a first test image or pattern having a first color (e.g., red), and can be displayed in a sequence or in series with a second test image or pattern having a second color (e.g., green), and/or a third test image or pattern having a third color (e.g., blue). Any of the test images described herein can be displayed independently or in combination with one or more other test images described herein (e.g., as part of a series or sequence of test images). As described above with reference to FIG. 4, the test image 566 can be displayed on the mobile phone's display screen 354 via the lighting elements 470a-b and one or more of the mobile phone's cameras. For example, one or more of the lighting elements 470a-b can emit light corresponding to the test image 566 that, when received by one or more of the mobile phone's cameras when the mobile phone is in a camera mode, cause the mobile phone's display screen 354 to display the test image 566. The test image 566, as displayed by the display screen 354, can be analyzed to determine a condition of the display screen 354, as described in greater detail below. In some embodiments, the analysis of the test image can include adjusting for one or more artifacts (e.g., visual artifacts) on the screen 354 of the phone 250 and/or in the as-displayed test image(s) 566. In at least some embodiments, for example, the image of the as-displayed test image(s) 566 captured by the camera(s) 462 can include reflections or glare, and the analysis can include masking or filtering the reflections or glare before determining the condition of the screen 354.

It will be appreciated that there are other ways to display the test image 566 on the mobile phone's display screen 354. For example, the kiosk 100 can interact with the mobile phone 250 to load the test image 566 on the mobile phone 250 and cause the screen 354 to display the test image 566. In these and other embodiments, a user can cause the screen 354 to display the test image 566. In some embodiments, displaying the test image 566 on the screen 354 can include at least one of the following: (i) directing a user to download an app on the phone 250, where the app is configured to display the test image 566; (ii) directing the user to access a website on the phone 250, where the website is configured to display the test image 566; and/or (iii) displaying the test image 566 on or proximate to the kiosk 100, and directing the user to take a picture of the test image 566 using the first camera 356 and/or the second camera 360 of the phone 250. However, in one or more of the above scenarios, the mobile phone 250 may be configured to turn off the screen 354 after a predetermined amount of time (e.g., 30 seconds, 2 minutes, 5 minutes, etc.). Accordingly, the analysis of the test image 566, as displayed by the display screen 354, may be constrained or limited by that predetermined amount of time. However, by displaying the test image 566 using the lighting elements 470 and directing the user to put the mobile phone 250 into camera mode and place the mobile phone 250 on the inspection plate 244 so that the test image 566 is displayed on the phone's display screen 354 via at least one of the phone's cameras while the mobile phone 250 is in camera mode, the screen 354 of the mobile phone can remain powered-on for a greater amount of time compared to when the mobile phone 250 is not in camera mode. For example, in at least some embodiments, the mobile phone's screen 354 can be configured to remain on or otherwise configured to not lock or turn off for as long as the mobile phone 250 is in camera mode. This, in turn, can increase the amount of time available for evaluating the mobile phone's display screen 354.

FIGS. 5B-5D are front views of screens 554a-c of electronic devices (e.g., mobile phones) viewed from the perspective of line A-A in FIG. 4. Each of the display screens 554a-c can be at least generally similar to or the same as the display screen 354 of FIGS. 3A and 4, and can be configured to display a displayed test image 567a-c, i.e., the test image 566 as displayed on the corresponding screen 554a-c. Each of the displayed test images 567a-c can be viewed or imaged by one or more cameras (e.g., the camera 462 of FIG. 4) and analyzed to determine a condition of the corresponding screen 554a-c. For example, if the displayed test image 567a-c is different than the test image 566 then the screen 554a-c may be damaged or otherwise in poor condition.

Determining the condition of the screens 554a-c can include identifying one or more gradients or changes in the associated displayed test images 567a-c from one portion (e.g., one or more pixels) to another portion (e.g., one or more adjacent pixels) of the screen 554a-c. The gradients can include variations or anomalies in one or more aspects of the displayed test images 566 across a length and/or a width of the screens 554a-c. The gradient can appear, for example, as portions or regions of the displayed test images 567a-c that have a reduced brightness, incorrect coloring, etc. The gradients can be identified based (e.g., solely based) on an analysis of the displayed test images 567a-c or a comparison of the displayed test images 567a-c to the test image 566. In some embodiments, the analysis of the displayed test images 567a-c can include calculating a standard deviation of one or more aspects of the displayed test images 567a-c. The standard deviation analysis of the displayed test images 567a-c can be used to determine an overall uniformity or consistency of the associated screens 554a-c. For example, a displayed test image 567a-c that is generally uniform (e.g., lacks gradients) can have a lower standard deviation relative to a displayed test image 567a-c that generally lacks uniformity (e.g., includes gradients). In some embodiments, the uniformity can be determined based at least partially on one or more of the standard deviation calculations associated with a given screen 554a-c. Accordingly, the uniformity of the displayed test images 567a-c can correspond to the presence, size, and/or severity of gradients in the functionality of the associated display 554a-c.

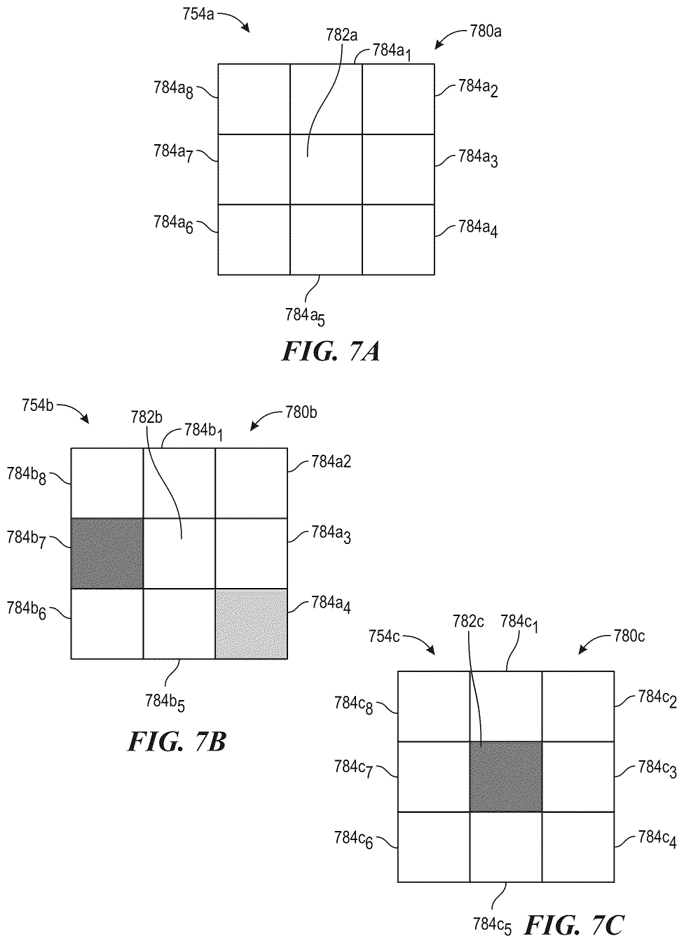

The standard deviation can be calculated on a pixel-by-pixel level on the screen 354 of the phone, wherein the color, brightness, etc. of adjacent pixels are compared and assigned a value. For example, the screen 354 can be configured to display a constant-color test image (e.g., white, red, green, blue, etc.), and a difference in color and/or brightness between one pixel and an adjacent pixel (e.g., any difference, or a difference greater than a predetermined threshold corresponding to, e.g., normal pixel-to-pixel screen variation for a given mobile phone and/or display screen type) can be recorded as a deviation value of “1.” The deviation values between the first pixel and each adjacent pixel can be summed to, e.g., determine an aggregated deviation value for all or a subset of the pixels in the display screen. The condition or quality of the display screen can be determined based, at least in part, on a calculated standard deviation of the aggregated deviation values for all or a subset of the pixels in the display screen, with a higher standard deviation indicating less uniformity in the overall displayed image, and therefore a more damaged or otherwise less functional screen 354. In some embodiments, the deviation value for each pixel can include a plurality or range of different values that each correspond to a severity or magnitude of the difference between adjacent pixels. For example, the difference between adjacent pixels can be scaled to one or more values between “0” (e.g., no difference) and “10” (e.g., significant difference). Generally, a higher standard deviation of the deviation values for each of the pixels for the displayed test image 567a-c can correspond to the presence of gradients in the associated display 554a-c, to gradients that occupy a greater area of the associated screen 554a-c, and/or to gradients that represent a greater magnitude change relative to one or more adjacent portions of the display 554a-c. This is described in further detail below with reference to FIGS. 7A-7C. Additionally, or alternatively, the standard deviation of the screens 554a-c can be calculated using a comparison between the displayed image 567a-c and the test image 566. In such embodiments, a pixel/region on one or more of the screens 554a-c is compared to a corresponding (e.g., same) pixel/region of the test image 566. A deviation value can be assigned to the screen 554a-c based on the differences in brightness, color, etc., between the displayed evaluation image 567a-c and the test image 566. In at least some embodiments, the standard deviation between the displayed image 567a-c and the test image 566 can be used to check whether the screen 554a-c is uniformly defective, for example, has little-to-no gradients across the screen 554a-c but is displaying an image that differs (e.g., different color(s), brightness(es), pattern(es), etc.) than the expected test image 566.

Referring to FIG. 5B, the displayed test image 567a is generally uniform and/or consistent. Accordingly, the screen 554a can have a low or zero standard deviation value as measured between individual pixels on the screen 554a, corresponding to the general uniformity of the displayed test image 567a. The low or zero standard deviation value can indicate that the condition of the screen 554a is good, functioning, relatively undamaged or free of damage, etc. If, however, the standard deviation of the pixels, when compared to an expected test image, is high, this could indicate widespread damage to the screen 554a. For example, if the test image is a uniform green image, and the screen 554a displays a uniform red image, the standard deviation calculated between pixels on the screen 554a would be low, but the standard deviation of the deviation values between the screen pixels and the expected test image would be high. These various standard deviation values can be applied to an evaluation of the functional state of the screen 554a-c and can be used to lower or raise a price offered to a user in exchange for their electronic device.

FIG. 5C illustrates a screen 554b is partially damaged or otherwise defective. Accordingly, the displayed test image 567b can include one or more zones or regions 568 that interrupt or otherwise differ from the test image 566. Each of the regions 568 can correspond to a portion of the screen 554b that is damaged, cracked, scratch, shattered, discolored, burned in, malfunctioning, or otherwise defective. For example, the regions 568 can have a different color and/or brightness than the test image 566, such that the regions 568 can create one or more gradients (e.g., between each of the regions 568 and the surrounding portions of the screen 554b) in the displayed test image 567b. The gradients created by the regions 568 can reduce the uniformity of the displayed test image(s) 567b. The reduction in uniformity can be determined by calculating the standard deviation of the pixel deviation values, as described previously with respect to FIG. 5B. Accordingly, the regions 568 can be identified and used to determine the condition of the screen 554b. Accordingly, the screen 554b of FIG. 5C can have a higher standard deviation value compared to the screen 554a of FIG. 5B, corresponding to the presence of the damaged and/or lower-functioning regions 568 in FIG. 5C that introduce gradients into the displayed test images 567b.

FIG. 5D illustrates a screen 554c that is entirely damaged or otherwise fully defective. For example, the entire screen 554c can be defective such that the displayed test image 567c is generally uniform but is displayed in one or more incorrect colors and/or brightness levels. In such embodiments, a standard deviation of the deviation values between adjacent pixels would indicate that the displayed test image 567c is generally uniform and thus incorrectly suggest that the screen 554c is in good condition. Accordingly, the evaluation of the screen 554c, and/or any of the other screens described herein, can further include comparing the displayed test image 567c with the test image 566, e.g., to determine whether the color and/or brightness of the displayed test image 567c are generally similar to or the same as those of the test image 566. In the illustrated embodiment, the color and/or brightness of the displayed test image 567c differs from the test image 566 (FIG. 5A), such that a comparison of the displayed test image 567c with the test image 566 would indicate that the display screen 554c is in poor condition. Accordingly, while the screen 554c of FIG. 5D can have a low standard deviation value between individual pixels than the screen 554b of FIG. 5B, a comparison of the displayed test image 567c with the test image 566 can indicate that the screen 554c is damaged or otherwise defective.

In some embodiments, machine learning can be used, at least in part, to determine the condition of the screens 554a-c, or any of the other screens described herein. The underlying machine learning algorithm(s) or process(es) can be configured to identify or recognize the screen 554a-c of the phone 250, identify or recognize defective regions 568 in the screens 354, compute the standard deviation of the pixels displayed test images 567a-c, compare the displayed test images 567a-c to the test image 566, and/or determine whether the screens 554a-c are damaged or otherwise defective.

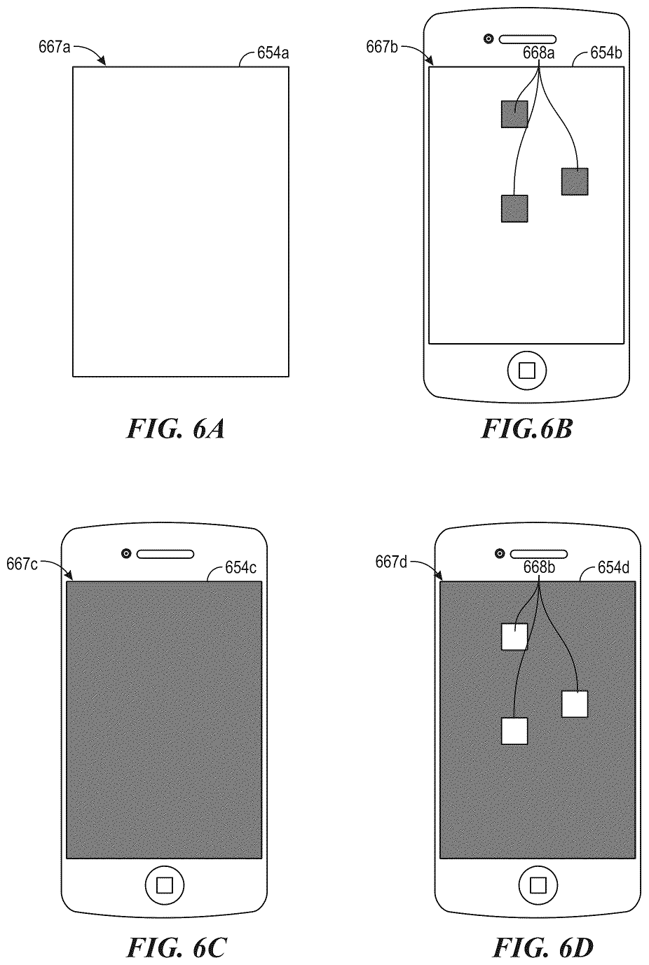

FIGS. 6A-6D are views of respective screens 654a-d of electronic devices, such as the mobile phone 250 of FIG. 4, from line A-A of FIG. 4. Each of the screens 654a-d can be generally similar to or the same as the screen 354 described previously herein. Each of the screens 654a-d can display a corresponding displayed test image 667a-d. Each of the displayed test images 667a-d can correspond to a test image associated with a lighting level within the inspection area. In the illustrated embodiment, the test images correspond to the light generated by one or more of the lighting elements 470a-b (FIG. 4) within the inspection area (FIG. 4). Specifically, the test image of FIGS. 6A and 6B corresponds to one or more of the lighting elements 470a-b being in an on or illuminating state, and the test image of FIGS. 6C and 6D corresponds to all the lighting elements 470a-b being off or inactive. In some embodiments, the test images can be displayed in sequence, e.g., the test image wherein one or more lighting elements 470a-b are activated is displayed first, followed by the test image wherein all of the lighting elements 470a-b are deactivated, to evaluate the mobile phone's display under multiple lighting conditions.

Referring to FIG. 6A, the test image (not shown) can correspond to a hue/brightness output by the lighting elements 470a-b. In at least some embodiments, for example, the lighting elements 470a-b can comprise white LEDs, and the test images can be at least partially or fully white or the color of the inner wall of the inspection area within the field of view of a camera of the mobile phone having the screen 654a (in the absence of defects in the screen 654a). The condition of the screen 654a can be determined based on the displayed test images 667a, as described previously with reference to FIGS. 5A-5D. As illustrated, the screen 654a is in good condition because the displayed test image 667a is generally uniform and generally similar to or the same as the test image.

Referring to FIG. 6B, the displayed test image 667b corresponds to the same test image as in FIG. 6B, but the displayed test image 667b also includes one or more defective regions 668. The regions 668a can be generally similar to or the same as the regions 568 of FIGS. 5A-5D, can be identified via a standard deviation and/or uniformity analysis as described previously, For example, when the lighting elements 470a-b are powered-on to provide the test image, the regions 668a can be darker (e.g., less intense, less luminous, differently colored, etc.) compared to the surrounding portions of the displayed test images 667a. This can create one or more gradients in the screen 654b, which can be reflected in a standard deviation calculation as described previously. Specifically, an analysis of the displayed test image 667a can indicate that the screen 654b is in poor condition.

Referring to FIG. 6C, the test image is generated in response to all the lighting elements 470a-b being off, and the displayed test image 667c is correspondingly dark/black, e.g., generally uniform and/or generally without any gradients. Accordingly, an analysis of the displayed test image 667c would indicate that the screen 654c is in good condition.

Referring to FIG. 6D, the display 654d is receiving the same test image as in FIG. 6C, but the displayed test image 667d includes one or more defective regions 668b. The regions 668b can be generally similar to the regions 568 of FIGS. 5A-5D. Because the test image is dark/black, the regions 668b can be lighter or brighter (e.g., more intense, more luminous, differently colored, etc.) than the surrounding portions of the displayed test image 667d. Accordingly, an analysis of the displayed test image 667d can indicate that the display 654d is in poor condition.

FIGS. 7A-7C illustrate respective pixel groups 780a-c, respectively (“the pixel groups 780”), in accordance with embodiments of the present technology. Each of the pixel groups 780a-c can include one or more pixels from a screen 754a-c of an electronic device. Each of the displays 754a-c can be generally similar to the screen 354 (FIG. 4) of the mobile phone 250, or any other screen described herein. Each of the pixels groups 780a-c includes a respective center or target pixel 782a-c and one or more neighboring pixels 784a-c adjacent or otherwise proximate to the target pixel 782a-c. In the illustrated embodiment, for example, each pixel group 780a-c includes eight neighboring pixels 784a₁₋₈, 784b₁₋₈, 784c₁₋₈, such that the neighboring pixels 784a-c surround or circumscribe the associated target pixel 782a-c.

The condition of the screens 754a-c can be determined based at least in part on an analysis of one or more pixels of the pixel groups 780a-c. In at least some embodiments, for example, at least one of the target pixels 782a-c can be compared to one or more of the associated neighboring pixels 784a-c. The analysis of the target pixels 782a-c can be generally similar to or the same as the analysis described previously and with reference to FIGS. 5A-6D. For example, the color and/or brightness of the target pixels 782a-c can be compared to the respective colors and/or brightness levels of the respective eight neighboring pixels 784a₁₋₈, 784b₁₋₈, 784c₁₋₈, to identify one or more gradients in the display. In other embodiments each of the target pixels 782a-c can have fewer neighboring pixels 784a-c. For example, in some embodiments the target pixels 782a-c may be positioned in a corner or along a perimeter of the associated display 754a-c and therefore have a reduced number of neighboring pixels.

Comparing the target pixels 782a-c with the neighboring pixels can include performing a convolution (e.g., a weighted average of the deviation value between the target pixels and their surrounding neighboring pixels) involving the target pixel 782a-c with at least one of the associated neighboring pixels 784a-c. For example, each of the screens 754a-c can be set to display a generally or substantially uniform image or pattern such that the target pixels 782a-c and the respective neighboring pixels 782a-c of each pixel groupings 780a-c are expected to have at least generally or the same colors and/or brightness levels. Accordingly, the presence of a gradient or difference in the color and/or brightness levels between the target pixel 782a-c and one or more of respective the neighboring pixels 782a-c can indicate the presence of at least one defective pixel (e.g., the target pixel or the neighboring pixel). This analysis can be performed for each pixel on the screen 754a-c and used to identify defective pixels and/or count a number of defective pixels in the screen 754a-c.

Additionally, or alternatively, each of the target pixels 782a-c can be compared with an expected or reference value as part of the pixel group analysis, e.g., to determine a condition of the target pixel 782a-c. This can be generally similar to or the same as the comparison of the test image 566 with the displayed test image 567c described previously regarding FIG. 5D, but performed on a pixel rather than a display. The expected value for the target pixel 782a-c can correspond to an area of a test image displayed on the associated screen 754a-c. In operation, the target pixel 782a-c can display part of the test image; the test image can be a generally or substantially uniform image (e.g., a single color with a constant brightness) and, if the portion of the image displayed by the target pixel 782a-c differs from the corresponding portion of the test image, then the target pixel 782a-c may be defective.

Referring to FIG. 7A, in the illustrated embodiment, the target pixel 782a has a same color and/or brightness as each of the neighboring pixels 784a₁₋₈. Accordingly, if the target pixel 782a is displaying a correct color and/or brightness, then an analysis of the pixel group 780a would not result in any pixels being identified as defective. If, however, the target pixel 782a is displaying an incorrect color and/or brightness, then the analysis of the pixel group 780a would result in the target pixel 782a and all the neighboring pixels 784a₁₋₈ being identified as defective.

Referring to FIG. 7B, in the illustrated embodiment, the neighboring pixels 784b₄ and 784b₇ both have different colors and/or brightness levels than the target pixel 782b. Accordingly, if the target pixel 782b is displaying a correct color and/or brightness, then an analysis of the pixel group 780b would result in the neighboring pixels 784b₄ and 784b₇ being identified as defective. If, however, the target pixel 782b is displaying an incorrect color and/or brightness, then the analysis of the pixel group 780b would result in the target pixel 782b and neighboring pixels 784b₁₋₃, 784b₅, 784b₆, and 784b₈ being identified as defective (e.g., the display 754b is showing a uniform test image in which are pixels are should have a same color and/or brightness, so any neighboring pixels 784 that match a defective target pixel 782 are expected to be defective). Additionally, if the target pixel 782b is defective, at least one of the remaining neighboring pixels, 784b₄ or 784b₇, can be identified as defective if it doesn't match the test image.

Referring to FIG. 7C, in the illustrated embodiment, each of the neighboring pixels 784c₁₋₈ have a same color and/or brightness, and target pixel 782c has a different color and/or brightness than the neighboring pixels 784c₁₋₈. Accordingly, an analysis of the pixel group 780c can further include a comparison of the color and/or brightness of the target pixel 782c relative to the expected value, as described previously. If the target pixel 782c is displaying a correct color and/or brightness, then the analysis of the pixel group 780c would identify each of the neighboring pixels 784c₁₋₈ as defective. If the target pixel 782c is displaying an incorrect color and/or brightness, then the analysis of the pixel group 780c would identify only the target pixel 782c as defective.

The Figures described herein and below include representative flow diagrams and other information that depict processes used in some embodiments of the present technology. These flow diagrams may not show all functions or exchanges of data, but instead they provide an understanding of commands and data exchanged under the systems described herein. Those skilled in the relevant art will recognize that some functions or exchange of commands and data may be repeated, varied, omitted, or supplemented, and other (less important) aspects not shown may be readily implemented. Those skilled in the art will appreciate that the blocks shown in the flow diagrams discussed below may be altered in a variety of ways. For example, while processes or blocks are presented in a given order, alternative implementations may perform routines in a different order, and some processes or blocks may be rearranged, deleted, moved, added, subdivided, combined, and/or modified to provide alternative or sub-combinations. Each of these processes or blocks may be implemented in a variety of different ways. Also, although processes or blocks are at times shown as being performed in series, these processes or blocks may instead be performed or implemented in parallel, or may be performed at different times. The steps depicted in the flow diagrams and/or represented by other tables, formulas, etc. can themselves include a sequence of operations that need not be described herein. Those of ordinary skill in the art can create source code, microcode, program logic arrays and/or computer-readable instructions to implement the depicted steps and routines based on the flowcharts and the detailed description provided herein. The routines and portions thereof can be stored in non-volatile memory (e.g., the memory 105 of FIG. 1) that forms part of a processor (e.g., the processor 103 of FIG. 1) contained in the kiosk 100 or otherwise associated with the kiosk 100 (e.g., a remote processor, such as the remote computing device 107 of FIG. 1, operably connected to the kiosk 100 via a wired/wireless communication link, etc.), or they can be stored in removable media, such as disks, or hardwired or preprogrammed in chips, such as EEPROM semiconductor chips.

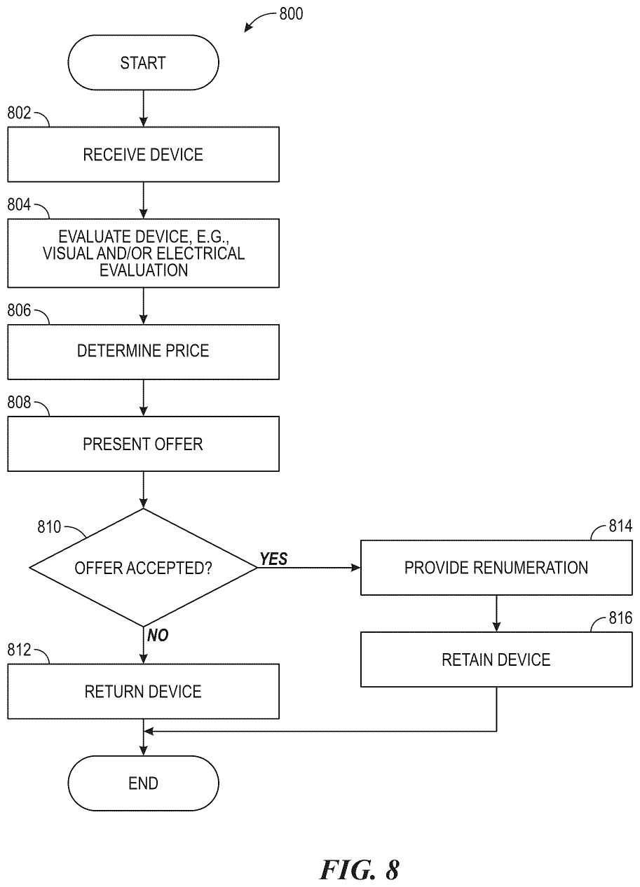

FIG. 8 is a flow diagram of a routine 800 that can be performed by the kiosk 100 for purchasing devices, e.g., mobile phones and/or other electronic devices, from users in accordance with an embodiment of the present technology. The routine can be executed by a processing device in accordance with computer-executable instructions stored on memory. The routine 800 is illustrated as a series of steps or blocks 802-816. Some or all of the blocks 802-816 can be performed by the remote computing device 107 and/or by the processor 103 of the kiosk 100 (FIG. 1). In block 802, the routine receives the device from the user (e.g., in the inspection area 108 of the kiosk 100 (FIGS. 1-2D and 4)). In block 804, the routine performs an evaluation, e.g., a visual and/or electrical inspection of the device, to determine various information about the device that can affect the device value. Such information can include, for example, the make, model, sub-model of the device, the device features (e.g., memory size, cell service carrier, etc.), device operability, device charge and/or rechargeability, physical condition, display function and condition, etc. After the device has been evaluated, the routine proceeds to block 806 to determine a price to offer the user for the device. In block 808, the routine presents the offer to the user (via, e.g., a textual message on the display screen 104, an audio speaker, etc.). In decision block 810, the routine determines if the user has accepted the offer price (by, e.g., providing input via a touch screen, keypad, microphone, etc. operably coupled to the kiosk 100). If the user declines the offer, the routine proceeds to block 812 and returns the device to the user. Conversely, if the user accepts the offer, the routine proceeds to block 814 and provides remuneration to the user in the amount of the purchase price. Such remuneration or payment can be in the form of, e.g., cash, a voucher redeemable for cash, merchandise, services, etc., electronic value (e.g., bitcoin, e-certificates, credit to electronic payment account, etc.), credit (e.g., a prepaid credit card, debit card, gift card, etc.), coupons, loyalty points, and/or other forms of value. In block 816, the routine retains the device (e.g., in the collection bin 234 of the kiosk 100) and the routine ends.

As those of ordinary skill in the art will appreciate, the foregoing routines are but some examples of ways in which the kiosk 100 can be used to recycle or otherwise process consumer electronic devices such as mobile phones. For example, in other embodiments the user can attach the electrical connector to the mobile phone 250 before the kiosk 100 performs a visual analysis of the phone. In such an embodiment, the user approaches the kiosk 100 and identifies the type of device (e.g., the make and model) he or she wishes to recycle, and/or the appropriate electrical connector for connecting to the device. The connector carrier 240 then rotates the appropriate connector 242 into position adjacent the transparent plate 244, and kiosk door 106 is opened. Next, the user may be prompted to remove any cases, stickers, or other accessories from the mobile phone 250. Additionally, the kiosk 100 may print and dispense a unique identification label from the label outlet 110 for the user to adhere to the back of the mobile phone 250. After this, the door 106 retracts and the user is instructed to withdraw the selected connector 242 from the carrier 240, plug it into the corresponding port (e.g., a USB port) on the mobile phone 250, and reposition the mobile phone 250 in the inspection area on the transparent plate 244. The door 106 then closes and the kiosk 100 can perform an electrical inspection of the mobile phone 250 as described above, and after the electrical inspection, a visual inspection of the mobile phone 250 as described above with respect to FIGS. 5A-7C. In some embodiments, the visual inspection is performed before the electrical inspection and/or instead of the electrical inspection. Although the foregoing example is described in the context of mobile phones, it should be understood that the kiosk 100 and various embodiments thereof can also be used in a similar manner for recycling virtually any consumer electronic device, such as MP3 players, tablet computers, PDAs, and other portable devices, as well as other relatively non-portable electronic devices such as desktop computers, printers, devices for implementing games, entertainment or other digital media on CDs, DVDs, Blu-ray, etc. Moreover, although the foregoing example is described in the context of use by a consumer, the kiosk 100 in various embodiments thereof can similarly be used by others, such as a store clerk, to assist consumers in recycling, selling, exchanging, etc. their electronic devices.

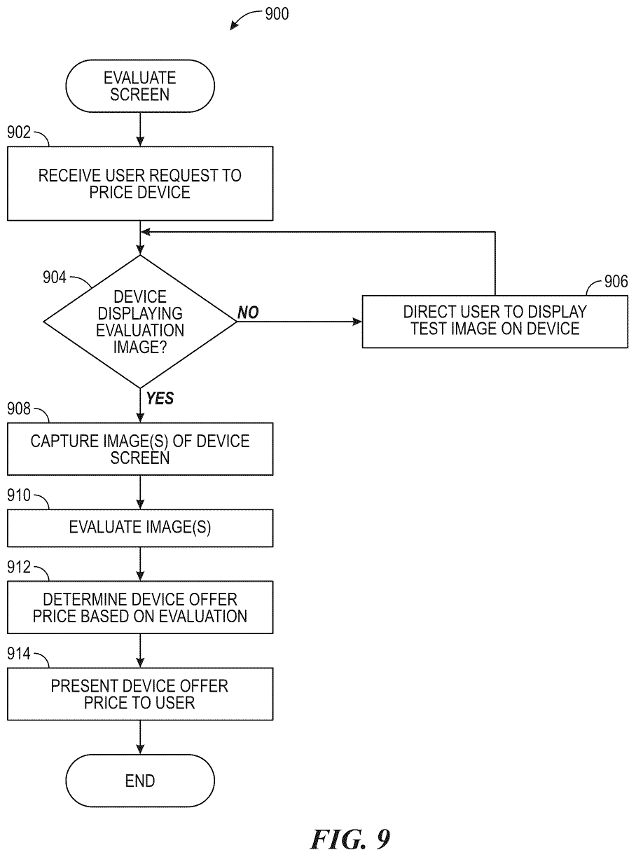

FIG. 9 is a flow diagram of a routine 900 for pricing electronic devices, such as the mobile phone 250 (FIGS. 2A-3), for recycling based at least in part on a determined condition of a screen (e.g., the screen 354, or any other screen described herein) of the electronic device, in accordance with embodiments of the present technology. Although described with reference to screen 354 of the mobile phone 250, a skilled artisan will appreciate that the routine 900 can be used to evaluate other screens and/or other devices. In various embodiments, one or more processors 103 of the kiosk 100, and/or another processing device operatively connectable to the kiosk 100, such as the remote computing device 107 (e.g., a server), can perform some or all of the routine 900. In some instances, for example, a user who owns a mobile phone 250 (e.g., a smartphone) may want to know how much the phone 250 is worth so that he or she can decide whether to sell it. The routine 900 of FIG. 9 enables the kiosk 100 to evaluate the condition of the screen 354 of the phone, such that a user can use the kiosk 100 to quickly obtain an offer price for the phone 250, (e.g., without requiring the user to manually provide information about the phone 250 and its condition and/or configuration).

In various embodiments, the routine 900 and the other flow routines described in detail herein can be implemented by a kiosk 100 that can obtain information about the mobile phone 250. The mobile phone 250 may be, for example, one of various consumer electronic devices, such as a used mobile telecommunication device, which includes all manner of handheld devices having wired and/or wireless communication capabilities (e.g., a smartphone, computer, TV, home automation device, etc.). In some embodiments, the user displays one or more test images on the screen 354 of the phone 250, e.g., such that the kiosk 100 can determine the condition of the screen 354 based at least partially or fully on the displayed test image(s). In some embodiments, the user downloads an app configured to display the test image(s) to the phone 250 from an app store or other software repository associated with the device manufacturer or a third party (e.g., the Apple® App Store, Google Play™ store, Amazon® Appstore™, and so on), from a website, from a kiosk such as the kiosk 100 (e.g., sideloading an app over a wired or wireless data connection), from a removable memory device such as an SD flash card or USB drive, etc. In some embodiments, the test images can be accessed via a website, and the user can be prompted by the kiosk 100 to visit the website using the phone 250. In some embodiments, the test image(s) can be displayed by, in, on, and/or otherwise proximate to the kiosk 100, and the user can take a picture of the test image(s), e.g., using at least one of the cameras (e.g., first camera 356, second camera 360) of the phone 250. In some embodiments, the kiosk 100 can prompt the user to place the phone 250 in a camera or video mode, and to position the phone 250 such that one or more lighting elements 470a-b, illuminated portions, or displays of the kiosk are within a field of view of one or more cameras of the phone 250.

In block 902, the routine 900 receives a user request to price the phone 250. For example, the user can activate the kiosk 100 (e.g., by interacting with the touch screen display 104 of the kiosk 100) and choose a function to begin a process to price one or more phones 250. In some embodiments, the kiosk 100 enables the user to select a particular phone 250 from a list of mobile phones corresponding to phones connected to the kiosk 100 and/or a list of mobile phones previously saved in the memory 105. In some instances, the phone 250 is electrically connected to the kiosk 100 (e.g., via one of the electrical connectors in the carousel 240 or via a wireless data connection), while in other instances, the phone 250 may be disconnected from the kiosk 100 when the user wants to find out how much the phone 250 is worth. In some embodiments, receiving a user request to price the phone 250 can include prompting a user to display at least one test image on the screen of the phone 250. The test image can be generally similar or the same as the test image 566 of FIG. 5, the test images of FIGS. 6A-6D, or any other suitable test image.

In decision block 904, the routine 900 determines whether the phone 250 is displaying a test image. For example, the kiosk's cameras 462 can be used to capture one or more images of the screen 354 of the phone 250 (e.g., a displayed test image, such as the displayed test images 567a-d of FIGS. 5A-D, the displayed test images 667a-d of FIGS. 6A-D, or any other suitable displayed test image), and the processor 103 can compare the captured image and the test image to determine whether the phone 250 is displaying the test image(s).

If the phone 250 is not displaying the test image, then in block 906 the routine 900 directs the user to take one or more actions to display the test image on the screen 354 of the phone 250. For example, the kiosk 100 can display instructions on the screen 104 directing the user to download an app, go to a specific website or URL, use the phone to take a picture of the test image, and/or place the phone 250 in a camera mode and to position the phone 250 such that one or more lighting elements 470a-b or displays are within the field of view of at least one of the phone camera's, as described previously herein. After block 906, the routine 900 returns to decision block 904. If the screen 354 of the phone 250 is inoperative or otherwise unable to display the test image, the routine 900 can proceed directly to block 912.

Once the phone 250 is displaying the test image, the routine 900 continues in block 908. In block 908, the kiosk 100 (e.g., via one or more cameras) captures or otherwise obtains one or more images of the displayed test image as displayed on the screen 354 of the phone 250. As described previously and with reference to FIG. 4, the phone 250 can be positioned in the inspection area 108 (e.g., on an inspection plate 244 and/or between the upper chamber 230 and the lower chamber 232). The upper chamber and/or the lower chamber 232 can each include one or more cameras 462 configured to image a first side 352 and/or a second side 358 of the phone 250, and at least one of the cameras 462 can be configured to capture an image of the screen 354 of the phone 250. The routine 900 can store the captured image of the screen 354 in the memory 105 and/or remotely from kiosk 100 (e.g., at the remote server 107, in a data structure maintained at a server computer, a cloud storage facility, another kiosk, etc.).

In block 910, the routine 900 evaluates the image captured in block 908. As described previously regarding FIGS. 5A-7C, the kiosk 100 can determine the condition of the screen 354 of the phone 250. For example, the kiosk 100 can analyze the captured image of the test image as displayed on the screen 354. In some embodiments, the kiosk 100 can analyze one or more target pixels 782 and/or neighboring pixels 784 of a pixel group 780 (FIG. 7A-C). Additionally, or alternatively, the kiosk 100 can calculate a standard deviation of the deviation values for the screen 354, identify any gradients in the screen 354, determine a uniformity of the displayed test image, etc. In some embodiments, this can include comparing the captured image(s) to one or more reference test images, e.g., stored in the memory 105, or otherwise available (e.g., via a wired or wireless communication connection) to the kiosk 100.

In some embodiments, as part of evaluating the phone 250, the kiosk 100 can further identify the phone 250 and/or assess its condition. For example, the kiosk 100 can identify the phone 250 by determining one or more of the target device platform, make, model, carrier (for a mobile phone, for example), features, configuration (e.g., memory and/or other storage capacity), upgrades, peripherals, etc. based on the target device information.

In block 912, the routine 900 determines an offer price for the phone 250 based at least in part on the evaluation performed in block 910. In some embodiments, the routine 900 can consult a local or remote database to price the phone 250 based on the information and the evaluation of the phone 250. For example, when the evaluation has determined the make, model, and configuration of the phone 250, the routine 900 can search a data structure that maps the make, model, and/or configuration of the phone to a price for the phone. In some embodiments, when the kiosk 100 has determined the condition of the screen 354, the routine 900 can search a data structure that maps the screen condition to a price for the phone. In some embodiments, the kiosk 100 can transmit some or all of the information received in block 908 and/or the results of the evaluation performed in block 910 to a remote server. The remote server can then use the information and/or evaluation results to determine the current market value of the phone 250 (such as by looking up the value of the phone 250 in a database) and return a price that the kiosk 100 can offer the user for the phone 250. In some embodiments, the kiosk 100 downloads pricing data from a remote server (e.g., the remote server 107 of FIG. 1), and determines an offer price for the phone 250 based on the pricing data downloaded from the server. For example, in some embodiments, the kiosk 100 can download a database of prices, such as a lookup table, pricing model, or other data structure containing prices for popular mobile phones. The kiosk 100 can use the information about the make and model of the phone 250 to look up the current value of the subject phone 250 in the table. In various embodiments, the pricing data is updated periodically, such as hourly, daily, or weekly. The routine 900 can ensure that such pricing data is kept current, so that the kiosk 100 offers only current, accurate prices. In some embodiments, the routine 900 can adjust the offer price based on the determined condition of the screen 354. For example, the offer price can be reduced based on the presence of damaged or defective regions in the screen 354 (e.g., the defective regions 568 of FIG. 5C, the defective regions 668a-b of FIGS. 6B and 6D) and/or based on the number of defective pixels (FIGS. 7A-C).

In block 914, the routine 900 presents the price for the phone 250 to the user. For example, the kiosk 100 can display the price on the display screen 104. For example, the routine 900 can indicate that the offer price will be valid for a certain period of time. In some embodiments, the kiosk 100 can lock down the inspection area prior to offering the price to the user. In some embodiments, if the user accepts the offered price for the phone 250, the kiosk 100 can transfer the phone 250 to the bin 234, as described previously and with reference to FIGS. 2A-D. After block 914, the routine 900 ends.

While various embodiments of the present technology are described herein using mobile phones and other handheld devices as examples of electronic devices, the present technology applies generally to all types of electronic devices. Such devices include, as non-limiting examples, all manner of mobile phones; smartphones; handheld devices; personal digital assistants (PDAs); MP3 or other digital music players; tablet, notebook, ultrabook and laptop computers; e-readers all types of cameras GPS devices; set-top boxes; universal remote controls; wearable computers; etc. In some embodiments, it is contemplated that the kiosk 100 can facilitate selling, evaluating, and/or otherwise processing larger consumer electronic devices, such as desktop computers, TVs, game consoles, etc., as well smaller electronic devices such as Google® Glass™, smartwatches (e.g., the Apple Watch™ Android Wear™ devices such as the Moto 360 ®, or the Pebble Steel™ watch), etc.

### INCORPORATED BY REFERENCE APPLICATIONS

Embodiments of the kiosk 100 and various features thereof can be at least generally similar in structure and function to the systems, methods and corresponding features described in the following patents and patent applications, which are incorporated herein by reference in their entireties: U.S. Pat. Nos. 11,482,067, 11,462,868, 11,080,672, 10,860,990, 10,853,873, 10,475,002, 10,445,708, 10,438,174, 10,417,615, 10,401,411, 10,269,110, 10,127,647, 9,885,672, 9,881,284, 8,200,533, 8,195,511, and 7,881,965; U.S. patent application Ser. Nos. 18/167,390, 17/811,548, 17/645,039, 17/445,821, 17/445,799, 17/445,178, 17/445,158, 17/445,083, 17/445,082, 17/125,994, 16/794,009, 16/719,699, 16/794,009, 16/534,741, 15/057,707, 14/967,183, 14/964,963, 14/663,331, 14/660,768, 14/598,469, 14/568,051, 14/498,763, 13/794,816, 13/794,814, 13/753,539, 13/733,984, 13/705,252, 13/693,032, 13/658,828, 13/658,825, 13/492,835, 13/113,497; U.S. Provisional Application Nos. 63/484,972, 63/365,778, 63/267,911, 63/220,890, 63/220,381, 63/127,148, 63/116,020, 63/116,007, 63/088,377, 63/070,207, 63/066,794, 62/950,075, 62/807,165, 62/807,153, 62/804,714, 62/782,947, 62/782,302, 62/332,736, 62/221,510, 62/202,330, 62/169,072, 62/091,426, 62/090,855, 62/076,437, 62/073,847, 62/073,840, 62/059,132, 62/059,129, 61/607,572, 61/607,548, 61/607,001, 61/606,997, 61/595,154, 61/593,358, 61/583,232, 61/570,309, 61/551,410, 61/472,611, 61/347,635, 61/183,510, and 61/102,304. All the patents and patent applications listed in the preceding sentence and any other patents or patent applications identified herein are incorporated herein by reference in their entireties.

### EXAMPLES

Several aspects of the present technology are described with reference to the following examples:
1. A kiosk system for recycling an electronic device having a display screen with a plurality of pixels, the kiosk system comprising:
a kiosk, including—
   a housing;
   an inspection area within the housing, wherein the inspection area is configured to receive the electronic device; and
   a camera positioned within the housing and configured to obtain one or more images of the display screen; and
one or more processors configured to execute instructions stored on non-transitory, computer-readable media, wherein execution of the instructions causes the one or more processors to—
   obtain an image of the display screen while the display screen is displaying a test image;
   based at least in part on the image of the display screen, determine a standard deviation of color and/or brightness for at least a subset of the plurality of pixels; and
   determine an offer price for the electronic device based at least in part on the standard deviation.
2. The kiosk of example 1 wherein the camera is a first camera, wherein the electronic device includes a second camera, wherein the kiosk further comprises one or more lighting elements positioned within the inspection area, and wherein execution of the one or more processors to activate individual ones of the one or more lighting elements to cause the second camera to receive light from the activated lighting elements and thereby cause the display screen to display the test image.
3. The kiosk of example 2 wherein the one or more lighting elements are positioned to directly illuminate the second camera, wherein the kiosk further comprises a kiosk display screen, and wherein execution of the instructions further causes the one or more processors to prompt a user, via the kiosk display screen, to—
activate a camera mode of the electronic device, and
place the electronic device within the inspection area with the second camera oriented toward the one or more lighting elements.
4. The kiosk of example 2 wherein the one or more lighting elements are positioned to illuminate a surface within the inspection area, wherein the kiosk further comprises a kiosk display screen, and wherein the instructions further cause the one or more processors to prompt a user, via the kiosk display screen, to—
activate a camera mode of the electronic device, and
place the electronic device within the inspection area with the second camera oriented toward the illuminated surface within the inspection area.
5. The kiosk of any of examples 2-4 wherein the second camera and the display screen are positioned on a same side of the electronic device.
6. The kiosk of any of examples 2-4 wherein the second camera and the display screen are positioned on different sides of the electronic device.
7. The kiosk of any of examples 2-6 wherein the test image is a first test image, and wherein execution of the instructions further causes the one or more processors to—
deactivate individual ones of the one or more lighting elements to cause the display screen to display a second test image different than the first test image; and
obtain one or more images of the display screen while the display screen is displaying the second test image.
8. The kiosk of any of examples 1-7 wherein the standard deviation is a standard deviation of brightness, and wherein, as part of determining the standard deviation, execution of the instructions causes the one or more processors to—
for at least one pixel in the subset—
   determine a first brightness of the at least one pixel,
   determine a second brightness of one or more adjacent pixels,
   determine a difference between the first brightness and the second brightness, and
   based at least in part on the difference, determine a condition of the display screen.
9. The kiosk of any of examples 1-8 wherein the standard deviation is a standard deviation of color, and wherein, as part of determining the standard deviation, the instructions cause the one or more processors to—
for at least one pixel in the subset—
   determine a first color of the at least one pixel,
   determine a second color of one or more adjacent pixels,
   determine a difference between the first color and the second color, and
   based at least in part on the difference, determine a condition of the display screen.
10. The kiosk of any of examples 1-9 wherein—execution of the instructions further causes the one or more processors to compare at least a
   portion of the test image displayed by the display screen with at least a corresponding
   portion of an expected test image, and the offer price is based at least in part on the standard deviation and the comparison.
11. The kiosk system of any of examples 1-10 wherein the one or more processors are one or more processors of the kiosk.
12. The kiosk system of any of examples 1-10 wherein the one or more processors are one or more processors of a remote computing device.
13. A computer-implemented method for evaluating an electronic device, the method comprising:
receiving an electronic device within an inspection area of a kiosk, wherein the electronic device includes a display screen comprising a plurality of pixels;
obtaining, via a camera of the kiosk, an image of the display screen of the electronic device while the display screen is displaying a test image;
determining a standard deviation of color and/or brightness for at least a subset of the plurality of pixels of the display screen based, at least in part, on the image of the display screen; and
determining an offer price for the electronic device based at least in part on the standard deviation.
14. The computer-implemented method of example 13 wherein the camera is a first camera, wherein the electronic device includes a second camera, and wherein the method further comprises activating one or more lighting elements positioned within the inspection area to cause the second camera to receive light from the activated lighting elements and thereby cause the display screen to display the test image.
15. The computer-implemented method of example 14, further comprising:
prompting a user to—
   put the electronic device in camera mode; and
   place the electronic device on the inspection area with the second camera oriented toward the one or more lighting elements.
16. The computer-implemented method of example 14, further comprising
prompting a user to—
   put the electronic device in camera mode; and
   place the electronic device on the inspection area with the second camera oriented toward a surface within the inspection area that is illuminated by the one or more lighting elements.
17. The computer-implemented method of any of examples 14-16 wherein the test image is a first test image, the method further comprising:
deactivating individual ones of the one or more lighting elements to cause the display screen to display a second test image different than the first test image; and
obtaining one or more images of the display screen while the display screen is displaying the second test image.
18. The computer-implemented method of any of examples 13-17 wherein the standard deviation is a standard deviation of brightness, and wherein determining the standard deviation includes—
for at least one pixel in the subset—
   determining a first brightness of the at least one pixel,
   determining a second brightness of one or more adjacent pixels,
   determining a difference between the first brightness and the second brightness, and
   based at least in part on the difference, determining a condition of the display screen.
19. The computer-implemented method of any of examples 13-17 wherein the standard deviation is a standard deviation of color, and wherein determining the standard deviation includes—
for at least one pixel in the subset—
   determining a first color of the at least one pixel,
   determining a second color of one or more adjacent pixels,
   determining a difference between the first color and the second color, and
   based at least in part on the difference, determining a condition of the display screen.
20. The computer-implemented method of any of examples 13-20 wherein the test image displayed by the display screen corresponds to an expected test image, the method further comprising:
comparing at least a first portion of the test image displayed by the display screen with at least a corresponding second portion of the expected test image,
wherein determining the offer price includes determining the offer price based, at least in part, of the standard deviation and the comparison of the test image and the expected test image.
21. The computer-implemented method of example 20 wherein the first portion of the test image includes a color of at least one of the plurality of pixels, wherein the second portion of the expected test image includes an expected color for the at least one of the plurality of pixels, and wherein comparing includes comparing the color to the expected color.
22. The computer-implemented method of example 20 or example 21 wherein the first portion of the test image includes a brightness of at least one of the plurality of pixels, wherein the second portion of the expected test image includes an expected brightness for the at least one of the plurality of pixels, and wherein comparing includes comparing the brightness to the expected brightness.
23. The computer-implemented method of any of examples 13-22 wherein the standard deviation and/or the offer price are determined via one or more processors of the kiosk.
24. The computer-implemented method of any of examples 13-22 wherein the standard deviation and/or the offer price are determined via one or more processors of a remote computing device.

### CONCLUSION

The present technology allows the screens of devices of various types, such as mobile phones (smartphones and feature phones, for example), tablet computers, wearable computers, game devices, media players, laptop and desktop computers, etc. (e.g., the phone 250) to be evaluated by an automated kiosk, such as the kiosk 100. The present technology enables the kiosk 100 to obtain information about an electronic device, such as the phone 250, determine a condition of a screen (e.g., the screen 354) of the device, obtain a price quote for the device, and present the price quote to a user such that the user can sell the device (e.g., at the kiosk 100) with greater certainty and speed.

The present technology includes various other types and embodiments of recycling machines. For example, the present technology includes embodiments such as a countertop recycling station and/or a retail store-based interface operated by or with the assistance of a retail employee (such as a partially automated system). As another example, the present technology includes embodiments such as a recycling machine configured to accept all kinds of devices, including larger items (e.g., desktop and laptop computers, televisions, gaming consoles, DVRs, etc.).

The above Detailed Description of examples and embodiments of the invention is not intended to be exhaustive or to limit the invention to the precise form disclosed above. Although specific examples for the invention are described above for illustrative purposes, various equivalent modifications are possible within the scope of the invention, as those skilled in the relevant art will recognize.

References throughout the foregoing description to features, advantages, or similar language do not imply that all of the features and advantages that may be realized with the present technology should be or are in any single embodiment of the invention. Rather, language referring to the features and advantages is understood to mean that a specific feature, advantage, or characteristic described in connection with an embodiment is included in at least one embodiment of the present technology. Thus, discussion of the features and advantages, and similar language, throughout this specification may, but do not necessarily, refer to the same embodiment.

Furthermore, the described features, advantages, and characteristics of the present technology may be combined in any suitable manner in one or more embodiments. One skilled in the relevant art will recognize that the present technology can be practiced without one or more of the specific features or advantages of a particular embodiment. In other instances, additional features and advantages may be recognized in certain embodiments that may not be present in all embodiments of the present technology.

Any patents and applications and other references noted above, including any that may be listed in accompanying filing papers, are incorporated herein by reference in the entirety, except for any subject matter disclaimers or disavowals, and except to the extent that the incorporated material is inconsistent with the express disclosure herein, in which case the language in this disclosure controls. Aspects of the invention can be modified, if necessary, to employ the systems, functions, and concepts of the various references described above to provide yet further implementations of the invention.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The teachings of the invention provided herein can be applied to other systems, not necessarily the system described above. The elements and acts of the various examples described above can be combined to provide further implementations of the invention. Some alternative implementations of the invention may include not only additional elements to those implementations noted above, but also may include fewer elements. Further any specific numbers noted herein are only examples: alternative implementations may employ differing values or ranges.

Although the above description describes various embodiments of the invention and the best mode contemplated, regardless how detailed the above text, the invention can be practiced in many ways. Details of the system may vary considerably in its specific implementation, while still being encompassed by the present technology. As noted above, particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed in the specification, unless the above Detailed Description section explicitly defines such terms. Accordingly, the actual scope of the invention encompasses not only the disclosed examples, but also all equivalent ways of practicing or implementing the invention under the claims.

From the foregoing, it will be appreciated that specific embodiments of the invention have been described herein for purposes of illustration, but that various modifications may be made without deviating from the spirit and scope of the various embodiments of the invention. Further, while various advantages associated with certain embodiments of the invention have been described above in the context of those embodiments, other embodiments may also exhibit such advantages, and not all embodiments need necessarily exhibit such advantages to fall within the scope of the invention. Accordingly, the invention is not limited, except as by the appended claims.

Although certain aspects of the invention are presented below in certain claim forms, the applicant contemplates the various aspects of the invention in any number of claim forms. Accordingly, the applicant reserves the right to pursue additional claims after filing this application to pursue such additional claim forms, in either this application or in a continuing application.

I/We claim:

1. A kiosk system for recycling an electronic device having a display screen with a plurality of pixels, the kiosk system comprising:
a kiosk, including—
a housing;
an inspection area within the housing, wherein the inspection area is configured to receive the electronic device; and
a camera positioned within the housing and configured to obtain one or more images of the display screen; and
one or more processors configured to execute instructions stored on non-transitory, computer-readable media, wherein execution of the instructions causes the one or more processors to—
obtain an image of the display screen while the display screen is displaying a test image;
based at least in part on the image of the display screen, determine a standard deviation of color and/or brightness for at least a subset of the plurality of pixels; and
determine an offer price for the electronic device based at least in part on the standard deviation.

2. The kiosk of claim 1 wherein the camera is a first camera, wherein the electronic device includes a second camera, wherein the kiosk further comprises one or more lighting elements positioned within the inspection area, and wherein execution of the one or more processors to activate individual ones of the one or more lighting elements to cause the second camera to receive light from the activated lighting elements and thereby cause the display screen to display the test image.

3. The kiosk of claim 2 wherein the one or more lighting elements are positioned to directly illuminate the second camera, wherein the kiosk further comprises a kiosk display screen, and wherein execution of the instructions further causes the one or more processors to prompt a user, via the kiosk display screen, to—
activate a camera mode of the electronic device, and
place the electronic device within the inspection area with the second camera oriented toward the one or more lighting elements.

4. The kiosk of claim 2 wherein the one or more lighting elements are positioned to illuminate a surface within the inspection area, wherein the kiosk further comprises a kiosk display screen, and wherein the instructions further cause the one or more processors to prompt a user, via the kiosk display screen, to—
activate a camera mode of the electronic device, and
place the electronic device within the inspection area with the second camera oriented toward the illuminated surface within the inspection area.

5. The kiosk of claim 2 wherein the second camera and the display screen are positioned on a same side of the electronic device.

6. The kiosk of claim 2 wherein the second camera and the display screen are positioned on different sides of the electronic device.

7. The kiosk of claim 2 wherein the test image is a first test image, and wherein execution of the instructions further causes the one or more processors to—
deactivate individual ones of the one or more lighting elements to cause the display screen to display a second test image different than the first test image; and
obtain one or more images of the display screen while the display screen is displaying the second test image.

8. The kiosk of claim 1 wherein the standard deviation is a standard deviation of brightness, and wherein, as part of determining the standard deviation, execution of the instructions causes the one or more processors to—
for at least one pixel in the subset—
determine a first brightness of the at least one pixel,
determine a second brightness of one or more adjacent pixels,
determine a difference between the first brightness and the second brightness, and
based at least in part on the difference, determine a condition of the display screen.

9. The kiosk of claim 1 wherein the standard deviation is a standard deviation of color, and wherein, as part of determining the standard deviation, the instructions cause the one or more processors to—
for at least one pixel in the subset—
determine a first color of the at least one pixel,
determine a second color of one or more adjacent pixels,
determine a difference between the first color and the second color, and
based at least in part on the difference, determine a condition of the display screen.

10. The kiosk of claim 1 wherein—
execution of the instructions further causes the one or more processors to compare at least a portion of the test image displayed by the display screen with at least a corresponding portion of an expected test image, and
the offer price is based at least in part on the standard deviation and the comparison.

11. The kiosk system of claim 1 wherein the one or more processors are one or more processors of the kiosk.

12. The kiosk system of claim 1 wherein the one or more processors are one or more processors of a remote computing device.

13. A computer-implemented method for evaluating an electronic device, the method comprising:
receiving an electronic device within an inspection area of a kiosk, wherein the electronic device includes a display screen comprising a plurality of pixels;
obtaining, via a camera of the kiosk, an image of the display screen of the electronic device while the display screen is displaying a test image;
determining a standard deviation of color and/or brightness for at least a subset of the plurality of pixels of the display screen based, at least in part, on the image of the display screen; and
determining an offer price for the electronic device based at least in part on the standard deviation.

14. The computer-implemented method of claim 13 wherein the camera is a first camera, wherein the electronic device includes a second camera, and wherein the method further comprises activating one or more lighting elements positioned within the inspection area to cause the second camera to receive light from the activated lighting elements and thereby cause the display screen to display the test image.

15. The computer-implemented method of claim 14, further comprising:
prompting a user to—
put the electronic device in camera mode; and
place the electronic device on the inspection area with the second camera oriented toward the one or more lighting elements.

16. The computer-implemented method of claim 14, further comprising
prompting a user to—
put the electronic device in camera mode; and
place the electronic device on the inspection area with the second camera oriented toward a surface within the inspection area that is illuminated by the one or more lighting elements.

17. The computer-implemented method of claim 14 wherein the test image is a first test image, the method further comprising:
deactivating individual ones of the one or more lighting elements to cause the display screen to display a second test image different than the first test image; and
obtaining one or more images of the display screen while the display screen is displaying the second test image.

18. The computer-implemented method of claim 13 wherein the standard deviation is a standard deviation of brightness, and wherein determining the standard deviation includes—
for at least one pixel in the subset—
determining a first brightness of the at least one pixel,
determining a second brightness of one or more adjacent pixels,
determining a difference between the first brightness and the second brightness, and
based at least in part on the difference, determining a condition of the display screen.

19. The computer-implemented method of claim 13 wherein the standard deviation is a standard deviation of color, and wherein determining the standard deviation includes—
for at least one pixel in the subset—
determining a first color of the at least one pixel,
determining a second color of one or more adjacent pixels,
determining a difference between the first color and the second color, and
based at least in part on the difference, determining a condition of the display screen.

20. The computer-implemented method of claim 13 wherein the test image displayed by the display screen corresponds to an expected test image, the method further comprising:
comparing at least a first portion of the test image displayed by the display screen with at least a corresponding second portion of the expected test image,
wherein determining the offer price includes determining the offer price based, at least in part, of the standard deviation and the comparison of the test image and the expected test image.

21. The computer-implemented method of claim 20 wherein the first portion of the test image includes a color of at least one of the plurality of pixels, wherein the second portion of the expected test image includes an expected color for the at least one of the plurality of pixels, and wherein comparing includes comparing the color to the expected color.

22. The computer-implemented method of claim 20 wherein the first portion of the test image includes a brightness of at least one of the plurality of pixels, wherein the second portion of the expected test image includes an expected brightness for the at least one of the plurality of pixels, and wherein comparing includes comparing the brightness to the expected brightness.

23. The computer-implemented method of claim 13 wherein the standard deviation and/or the offer price are determined via one or more processors of the kiosk.

24. The computer-implemented method of claim 13 wherein the standard deviation and/or the offer price are determined via one or more processors of a remote computing device.
